(19) United States
(12) Patent Application Publication
(10) Pub. No.: US 2013/0114512 A1
(43) Pub. Date: May 9, 2013

(54) BASE STATION DEVICE, INTER-BASE-STATION SYNCHRONIZATION METHOD, DATA STRUCTURE OF SYNCHRONIZATION INFORMATION, AND DATA STRUCTURE OF SYNCHRONIZATION REQUEST

(71) Applicant: Takashi Yamamoto, Osaka-shi (JP)

(72) Inventor: Takashi Yamamoto, Osaka-shi (JP)

(73) Assignee: SUMITOMO ELECTRIC INDUSTRIES, LTD., Osaka-shi, Osaka (JP)

(21) Appl. No.: 13/808,929

(22) PCT Filed: Aug. 5, 2011
(86) PCT No.: PCT/JP2011/067947

§ 371 Date: Jan. 8, 2013

(30) Foreign Application Priority Data
Aug. 9, 2010 (JP) 2010-178758

(51) Int. Cl. H04W 56/00

(52) U.S. Cl. CPC H04W 56/001
USPC 370/328

(57) ABSTRACT

A base station device includes a transmission unit 27 which transmits, via an X2 interface 26, a synchronization request that requests another base station device to achieve inter-base-station synchronization with the base station device; and a reception unit 27 which receives synchronization information relating to the synchronization state of inter-base-station synchronization, which information is transmitted from the another base station device via the X2 interface 26.

### TECHNICAL FIELD

The present invention relates to a base station device that communicates with mobile terminals and the like, and an inter-base-station synchronization method, a data structure of synchronization information, and a data structure of a synchronization request which are used by the base station device.

### BACKGROUND ART

In a wireless communication system having a plurality of base station devices, if communication areas (cells) formed by the respective base station devices overlap each other, a signal transmitted from a certain base station device may reach a terminal device existing in a cell of another base station device located near the certain base station device, and may become an interference signal for the terminal device.

It is well known that such interference can be suppressed by beam forming. That is, a base station device performs beam forming such that a beam is directed to a terminal device existing in its own cell (hereinafter, also referred to as “own terminal device”) while a null beam is directed to a terminal device existing in a cell of another base station device (hereinafter, also referred to as “another terminal device”). Thereby, a signal (interference signal) transmitted from the base station device becomes less likely to arrive at the another terminal device, and thus interference is suppressed (refer to Non-Patent Literature 1 for beam forming).

### Citation List

### [Non Patent Literature]

Non-Patent Literature 1: “Adaptive Signal Processing Using Array Antennae”, written by Nobuyoshi KIKUMA, published by Kagaku Gijutsu Shuppan, Nov. 25, 1998

### SUMMARY OF THE INVENTION

### Problems to be Solved by the Invention

By the way, there is a wireless communication system including, as base station devices, a macro base station device that forms a cell (macro cell) having a size of several kilometers, and a femto base station device that is located in the macro cell and forms a relatively small cell (femto cell) having a size of several tens of meters in the macro cell.

In the wireless communication system, the femto cell of the femto base station device is sometimes formed in the macro cell, and almost the entire area of the femto cell may overlap the macro cell. Further, the femto base station device is sometimes installed in an arbitrary place in the macro cell by the user.

Therefore, a downlink signal from the femto base station device may interfere with a terminal device connected to the macro base station device, or an uplink signal transmitted from a terminal device connected to the femto base station device may interfere with the macro base station device.

Furthermore, a plurality of femto base station devices that form neighboring femto cells and terminal devices connected to the femto base station devices may interfere with each other.

Thus, various situations that cause interference are considered. Therefore, even if the base station device adopts the beam forming, it is difficult to appropriately suppress interference in the above-mentioned various situations.

Of the above-described interferences, as a measure against the interference caused by that a terminal device connected to a macro base station device is located near a femto base station device and thereby interfered with by a downlink signal from the femto base station device, it is considered to make a resource allocated to the terminal device connected to the macro base station device and a resource used by the femto base station device different from each other in the frequency direction or the time direction. This setting prevents the downlink signals of the base station devices from overlapping each other, and thereby prevents the interference.

Sifting resources-to-be-used in the frequency direction may cause the following problems. That is, for example, when the wireless communication system adopts LTE, a control channel in which a control signal and the like are stored is arranged at the beginning of each downlink subframe and over the entire frequency band of the subframe. Therefore, even when resources are allocated in different frequency bands between one base station device and another base station device, control channels thereof might overlap each other over the entire frequency band, which might cause interference. If control signals transmitted by using the control channels interfere with each other, terminal devices that receive the control signals might fail to normally recognize data signals.

Moreover, regarding the data signals, even when the resources are used in different frequency bands, the data signals overlap each other when viewed in the time domain. Therefore, if the reception power of one of the data signals is excessively smaller than that of the other data signal, it might be difficult to normally receive the one data signal separated from the other data signal.

As described above, when shifting the resources-to-be-used from each other in the frequency direction, interference between the base station devices might not be completely suppressed. Therefore, it is also needed to relatively adjust the powers of transmission signals between the base station devices.

On the other hand, shifting the resources-to-be-used from each other in the time direction causes no overlapping of the data signals in the time domain. Further, regarding the control signals, since no control signal is substantially transmitted to a control channel of a subframe corresponding to a time to which no resource is allocated, it is possible to suppress interference with the other control signal without adjusting the powers of the transmission signals between the base station devices.

However, in order to shift the resources in the time direction, the transmission timings of radio frames need to be synchronized between the base station devices.

As described above, in order to suppress the interference to the terminal device connected to the macro base station device due to the downlink signal from the femto base station device located near the terminal device, it is necessary to perform an appropriate process in accordance with the state of synchronization between the base station devices.

Therefore, an object of the present invention is to provide: a base station device which can comprehend the state of synchronization with another base station device, and perform a process to appropriately avoid interference in accordance with the state of synchronization; and an inter-base-station synchronization method, a data structure of synchronization information, and a data structure of a synchronization request which are used by the base station device.

### Solution to the Problems

(1) A base station device according to the present invention includes a reception unit which receives, via an inter-base-station communication interface that enables inter-base-station communication, synchronization information relating to a synchronization state of inter-base-station synchronization, the synchronization information being transmitted from another base station device.

The base station device of the above configuration can comprehend the synchronization state of the another base station device, based on the synchronization information transmitted from the another base station device.

The “synchronization state” means conditions and parameters for inter-base-station synchronization, such as a synchronization target to be a reference of the inter-base-station synchronization, and an amount of offset of a radio-frame transmission timing with respect to the synchronization target.

(2) The base station device preferably includes a transmission unit which transmits, via the inter-base-station communication interface, a synchronization request that requests the another base station device to achieve inter-base-station synchronization with the base station device. In this case, the base station device can request the another base station device to perform inter-base-station synchronization.

(3) More specifically, the synchronization request preferably includes an amount of timing offset of a communication timing to be adjusted by the another base station device.

(4), (5) Further, in order to comprehend the synchronization state of the another base station device more specifically, the synchronization information may include a clock synchronization target with which the another base station device synchronizes its own internal clock. Further, the synchronization information may include an amount of timing offset between a communication timing of the base station device and a communication timing of the another base station device.

(6) The base station device preferably includes: a detection unit which detects for, among terminal devices connected to the base station device, a terminal device that is located so close to the another base station device that it is likely to be interfered with by a downlink signal from the another base station device; and a control unit which, when the detection unit detects such a terminal device located close to the another base station device, generates, based on the synchronization information, a processing request for requesting the another base station device to execute an interference avoidance process for avoiding interference between the terminal device and the another base station device, and then causing the transmission unit to transmit the processing request to the another base station device.

In this case, it is possible to execute an appropriate interference avoidance process based on the synchronization state of the another base station device, by transmitting the processing request that requests, based on the synchronization information, the another base station device to perform the interference avoidance process.

(7), (8) The processing request preferably requests the another base station device to provide vacant resources for avoiding interference between the another base station device and the terminal device located close to the another base station device.

In this case, the control unit preferably determines, based on the synchronization information, whether the communication timing of the another base station device is synchronized with that of the base station device, and generates, upon determining that the communication timings are synchronized with each other, a processing request that requests the another base station device to secure the vacant resources in predetermined time units.

In this case, the control unit can cause the another base station device to secure the vacant resources in the predetermined time units, when the communication timings of the base station device and the another base station device are synchronized with each other, and can specify a range corresponding to the vacant resources. Therefore, it is possible to allocate favorable resources with which mutual interface can be avoided, to the terminal device located close to the another base station device. As a result, it is possible to perform the process for avoiding interference more appropriately.

(9) A base station device of the present invention further includes a transmission unit which transmits synchronization information relating to a synchronization state of inter-base-station synchronization, to another base station device via an inter-base-station communication interface that enables inter-base-station communication.

According to the base station device of the above configuration, it is possible to cause the another base station device to comprehend the synchronization state of the base station device, by transmitting the synchronization information to the another base station device.

(10) The present invention is an inter-base-station synchronization method for achieving synchronization between base station devices, comprising the steps of: transmitting, from one of the base station devices to the other base station device, an synchronization request that requests the other base station device to achieve inter-base-station synchronization with the one base station device, via an inter-base-station communication interface that allows inter-base-station communication; and transmitting, from the other base station device to the one base station device, synchronization information relating to a synchronization state of inter-base-station synchronization via the inter-base-station communication interface.

According to the inter-base-station synchronization method configured as described above, the one base station device can request the other base station device to achieve inter-base-station synchronization, and can comprehend the synchronization state of the other base station device, based on the synchronization information from the other base station device.

(11) The present invention is a data structure of synchronization information transmitted from a computer of a base station device, and the synchronization information indicates information relating to a synchronization state of inter-base-station synchronization in the base station device, and includes synchronization target information indicating a synchronization target in the inter-base-station synchronization.

According to the data structure of the above configuration, a recipient that has received the synchronization information from the base station device can comprehend, based on the synchronization information, the synchronization target with which the base station device has performed inter-base-station synchronization.

(12) The present invention is a data structure of a synchronization request transmitted from a computer of a base station device, and the synchronization request indicates that the base station device requests another base station device to perform inter-base-station synchronization, and includes synchronization target information indicating a synchronization target in the inter-base-station synchronization.

According to the data structure of the above configuration, the base station device can request a recipient that has received the synchronization request to achieve inter-base-station synchronization, with the synchronization target being designated.

### Advantageous Effects of the Invention

According to the present invention, a base station device can comprehend the state of synchronization with another base station device, and appropriately perform a process of avoiding interference in accordance with the state of synchronization.

### BRIEF DESCRIPTION OF THE DRAWINGS

FIG. 1 illustrates an overall configuration of a wireless communication system including base station devices according to an embodiment of the present invention.

FIG. 2 is a diagram illustrating an example of a communication network in which the BSs are connected.

FIG. 3 is a schematic diagram illustrating the structure of a downlink radio frame (DL frame) for LTE.

FIG. 4 is a block diagram illustrating the configuration of a macro base station device.

FIG. 5 is a diagram illustrating process steps relating to management of the synchronization state of inter-base-station synchronization performed between a macro base station device and a femto base station device.

FIG. 6 is a diagram illustrating the content of request messages included in a synchronization request.

FIG. 7 is a diagram illustrating the content of report messages included in synchronization information.

FIG. 8 is a diagram illustrating process steps relating to an interference avoidance process performed by a macro base station device with a femto base station device.

FIG. 9 is a diagram for explaining a process in which a macro base station device detects, from terminal devices connected to the macro base station device, a terminal device located close to a femto base station device.

FIG. 10 is a diagram illustrating examples of measurement results transmitted to the macro base station device when the macro base station device transmits a measurement request to a plurality of terminal devices connected to the macro base station device in FIG. 1.

FIG. 11(a) is a diagram illustrating examples of resource allocations performed by the macro base station device and the femto base station device shown in FIG. 1 when radio-frame-timing synchronization is not achieved between the base station devices, and FIG. 11(b) is a diagram illustrating examples of resource allocations performed by the macro base station device and the femto base station device shown in FIG. 1 when radio-frame-timing synchronization is achieved between the base station devices.

### DESCRIPTION OF EMBODIMENTS

Hereinafter, a preferred embodiment of the present invention will be described with reference to the accompanying drawings.

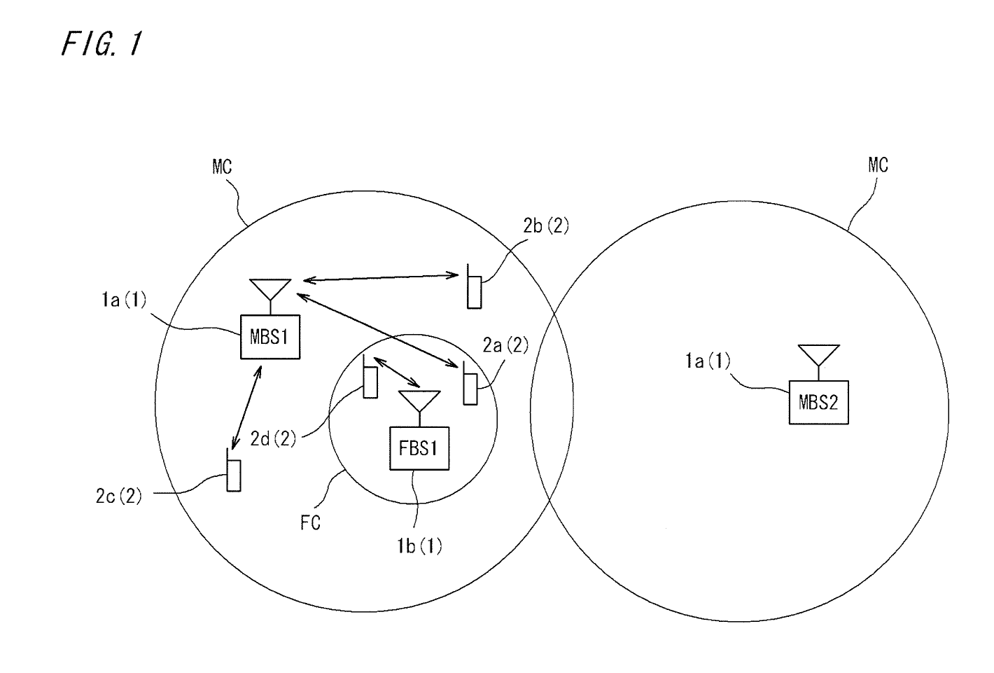

FIG. 1 shows an overall configuration of a wireless communication system including a base station device according to an embodiment of the present invention. The wireless communication system of the present embodiment is, for example, a system for mobile phones to which LTE (Long Term Evolution) is applied, and communication based on the LTE is performed between each base station device and each terminal device. However, the communication scheme is not limited to the LTE.

The wireless communication system includes a plurality of base station devices 1, and a plurality of terminal devices (Mobile Stations) 2. Each terminal device 2 is allowed to wirelessly access any of the base station devices 1, and communicate with the base station device 1.

Examples of the base station devices 1 provided in the wireless communication system include: a plurality of macro base station devices (Macro Base Stations) 1a each forming a communication area (macro cell) MC having a size of several kilometers; and a plurality of femto base station devices (Femto Base Stations) 1b each being installed in the macro cell MC or the like, and forming a relatively small femto cell FC having a size of several tens of meters. In FIG. 1, regarding the femto base station devices 1b, only a femto base station device 1b (FBS1) installed in the macro cell MC of the macro base station device 1a (MBS1) is shown in order to simplify the description.

The macro base station device (hereinafter, also referred to as “macro BS”) 1a can perform wireless communication with the terminal devices 2 existing in its own macro cell MC.

The femto base station device (hereinafter, also referred to as “femto BS”) 1b is installed in a place, such as indoors, where it is difficult for the terminal devices to receive a radio signal from the macro BS 1a, and forms a femto cell FC.

The femto BS 1b can wirelessly communicate with the terminal devices (hereinafter, also referred to as “MS”) 2 existing in its own femto cell FC. In this system, since the femto BS 1b that forms a relatively small femto cell FC is installed in a place where it is difficult for the MS 2 to receive a radio signal from the macro BS 1a, it is possible to provide services with sufficient throughput to the MS 2.

In FIG. 1, it is assumed that an MS 2a, an MS 2b, and an MS 2c are connected to the macro BS 1a (MBS1), and an MS 2d is connected to the femto BS 1b (FBS1).

In order that the MS 2 is connected to the femto BS 1b, the MS 2 needs to be registered in the femto BS 1b in advance. If the MS 2 is not registered, even the MS 2a located in the femto cell FC as shown in FIG. 1 cannot be connected to the femto BS 1b, but is connected to the macro BS 1a.

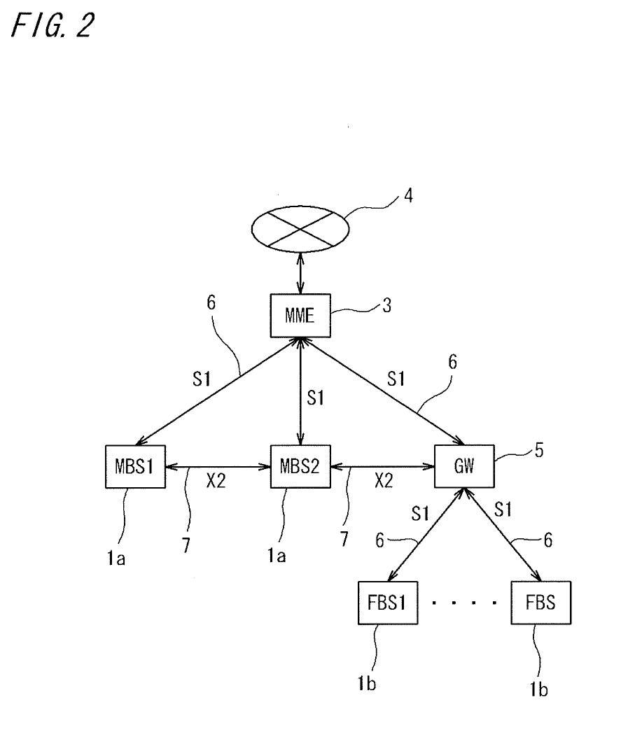

FIG. 2 is a diagram showing an example of a communication network for connecting the BSs. Each macro BS 1a is connected to a communication network 4 of the wireless communication system via an MME (Mobility Management Entity) 3. The MME 3 is a node that manages the location and the like of each MS 2, and performs a process relating to mobility management for each MS 2.

Each femto BS 1b is connected to the MME 3 via a gateway 5 (GW). Connection between the MME 3 and each macro BS 1a, connection between the MME 3 and the gateway 5, and connection between the gateway 5 and each femto BS 1b are each achieved by a line 6 using a communication interface called “S1 interface”.

Further, the macro BSs 1a are connected to each other by a line 7 using an inter-base-station communication interface called “X2 interface”, which allows communication for direct information exchange between the base station devices. Further, the gateway 5 is also connected to the macro BS 1a by a line 7 using the X2 interface.

The X2 interface is provided for the purpose of exchanging, for example, information relating to mobility management such as handover in each MS 2 that moves between the base station devices. Although such a function overlaps with the function of the MME 3, the X2 interface for inter-base-station communication is provided for the following reasons. That is, if the MME 3 solely performs mobility management for all the MSs 2 connected to the respective macro BSs 1a, an enormous amount of processing concentrates on the MME 3. In addition, mobility management can be performed more efficiently between the base station devices.

In FIG. 2, the macro BS 1a directly connected to the MME 3 is sometimes referred to as eNB (Evolved NodeB), the gateway 5 as Home-eNB Gateway, and the femto BS 1b as Home-eNB.

In the LTE applied to the wireless communication system, frequency division duplex (FDD) is adopted. In the FDD, uplink communication and downlink communication can be simultaneously performed by allocating different operating frequencies to an uplink signal (a transmission signal from a terminal device to a base station device) and a downlink signal (a transmission signal from the base station device to the terminal device).

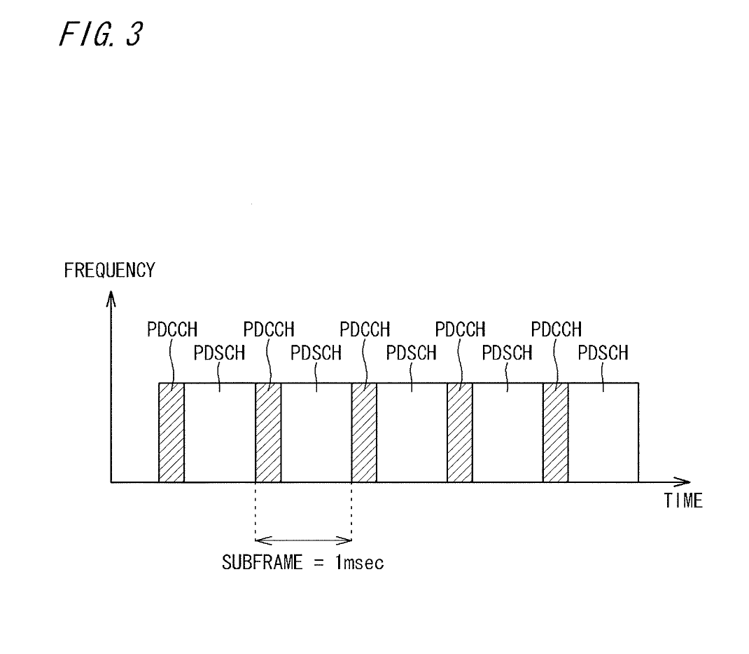

FIG. 3 schematically shows the structure of a downlink radio frame (DL frame) for the LTE. A DL frame is composed of 10 subframes arrayed in the time-axis direction (note that FIG. 3 shows a part of a DL frame). A subframe has a length corresponding to 14 OFDM symbols (=1 msec) in the time-axis direction, and a frequency bandwidth of 20 MHz at maximum.

Each subframe has, at its beginning, a control area in which control information is stored, and the control area is followed by a physical downlink shared channel (PDSCH) in which user data is stored. The control area is secured over three symbols at maximum in the time-axis direction, and over the entire frequency bandwidth of each subframe in the frequency axis direction.

In the control area, a physical downlink control channel (PDCCH) for transmitting downlink and uplink allocation information and the like is secured. The PDCCH includes, in addition to the allocation information, information of an uplink transmission power limit value, and information relating to an instruction for report of a downlink CQI (Channel Quality Indicator), and the like. The size of the PDCCH varies depending on the size of the control information.

In addition to the PDCCH, the following channels are allocated in the control area: a physical control format indicator channel (PCFICH) for notifying information relating to the PDCCH; and a physical hybrid-ARQ indicator channel (PHICH) for transmitting an acknowledgement (ACK) or a negative acknowledgement (NACK) in response to a hybrid automatic repeat request (HARQ) to a PUSCH.

The PDSCH in which user data and the like are stored is an area shared by a plurality of terminal devices, and control information and the like for each terminal device is also stored in the PDSCH in addition to the user data.

The PDSCH is configured to have a plurality of resource blocks (RB). Each resource block is a fundamental unit area (a minimum unit for radio resource allocation) for data transmission. Each resource block has a size corresponding to 12 subcarriers in the frequency-axis direction and 7 OFDM symbols in the time-axis direction.

When the frequency bandwidth of the DL frame is set at 10 MHz, 600 subcarriers are arrayed. Accordingly, in a subframe, 50 resource blocks are arranged in the frequency-axis direction, and the number of resource blocks in the time-axis direction is 2.

Further, a synchronization signal comprising a known signal is allocated at predetermined positions in the leading (first) subframe and the sixth subframe, among the 10 subframes that constitute a DL frame.

The base station device 1 has a function of determining allocation of resource blocks as radio resources to terminal devices, and determining a transmission power value for each resource block. Further, like the DL frame, an uplink radio frame (UL frame) based on the LTE also has a plurality of resource blocks, and allocation of the resource blocks of the DL frame to terminal devices is also determined by the base station device 1.

The downlink and uplink resource block allocations determined by the base station device 1 are stored in the PDCCH as allocation information, and the allocation information is transmitted from the base station device 1 to a terminal device 2. The base station device 1 and the terminal device 2 perform communication by using the resource blocks in accordance with the determined allocation information.

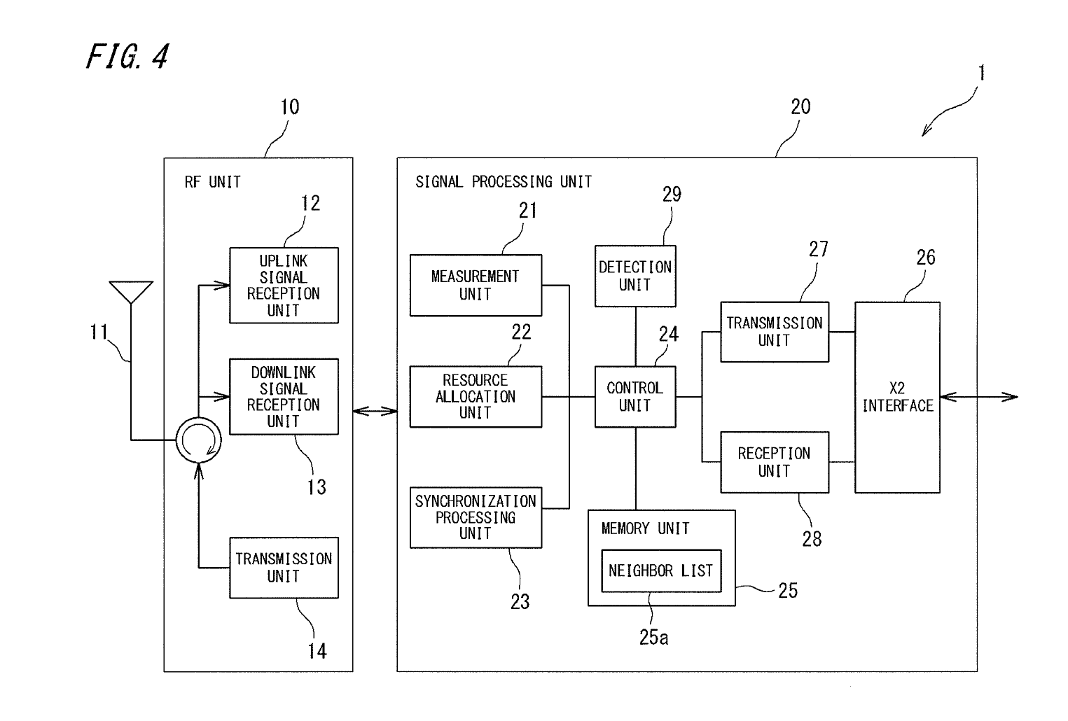

FIG. 4 is a block diagram illustrating the configuration of the macro base station device 1. Although the configuration of the macro BS 1a will be described hereinafter, the configuration of the femto BS 1b is similar to that of the macro BS 1a.

The macro base station device 1 includes an antenna 11, a transmission/reception unit (RF unit) 10 to which the antenna 11 is connected, and a signal processing unit 20 that performs a process for suppressing interference to another cell (a base station device or a terminal device in another cell), and the like, as well as signal processing for signals transmitted/received between MSs 2, which are exchanged with the RF unit 10.

The RF unit 10 includes an uplink signal reception unit 12, a downlink signal reception unit 13, and a transmission unit 14. The uplink signal reception unit 12 receives an uplink signal from an MS 2. The downlink signal reception unit 13 receives a downlink signal from another macro BS 1a or another femto BS 1b. The transmission unit 14 transmits a downlink signal to an MS 2.

In the present embodiment, the downlink signal reception unit 13 is used for sniffing a downlink signal from another base station device 1, and observing (measurement) the downlink signal. A downlink reception signal outputted from the downlink signal reception unit 13 is given to the signal processing unit 20, and is processed by a measurement unit 21 or a demodulation unit (not shown).

The signal processing unit 20 is configured by a processor (microcomputer) capable of generating various kinds of information, and functionally includes the measurement unit 21 performing measurement, a resource allocation unit 22, and a synchronization processing unit 23.

The measurement unit 21 periodically performs measurement to obtain, based on a downlink reception signal from another base station device 1 which is received by the downlink signal reception unit 13, a transmission power and an operating frequency of the another base station device 1, a synchronization signal indicating a radio frame timing, and the like. Further, the measurement unit 21 also has a function of obtaining a cell ID or the like that is a unique ID given to the another base station device 1, and identifying the another base station device 1.

The resource allocation unit 22 performs allocation of resource blocks to each MS 2 wirelessly connected to the macro BS 1a, with respect to the uplink and downlink subframes of the macro BS 1a. Further, the resource allocation unit 22 also has a function of setting, for each resource block, a transmission power of a downlink transmission signal of the macro BS 1a and a transmission power of an uplink transmission signal of a terminal device 2 connected to the macro BS 1a.

The resource allocation unit 22 performs resource allocation to each MS 2 connected to the macro BS 1a by using resources in a range that the macro BS 1a can use, which range is determined by a control unit 24 (described later) of the macro BS 1a or another base station device 1 in accordance with a synchronization state between the macro BS 1a and the another base station device 1.

The synchronization processing unit 23 has a function of performing a synchronization process to achieve inter-base station synchronization with wireless communication of another base station device. Specifically, the synchronization processing unit 23 has a function of correcting its own internal clock with respect to a predetermined reference clock to adjust the length of its own radio frame in the time direction, and a function of adjusting a communication timing of its own radio frame.

In accordance with a reference clock given from the control unit 24, the synchronization processing unit 23 synchronizes the length of its own radio frame with the length of a radio frame determined by the reference clock (clock synchronization).

Further, the synchronization processing unit 23 synchronizes the timing of its own radio frame with the timing of a reference radio frame given by the control unit 24 (timing synchronization).

Utilizing a synchronization signal included in a downlink signal of another base station device, which is obtained by the measurement unit 21, the synchronization processing unit 23 may obtain the timing of a radio frame in the downlink signal of the another base station device to perform the above-described synchronization process (over-the-air synchronization). Alternatively, the synchronization processing unit 23 may perform the synchronization process based on information obtained by wire communication via an X2 interface 26 described later.

The signal processing unit 20 further includes: the control unit 24 that controls processes relating to synchronization with another base station device 1, and interference avoidance; a memory unit 25 in which information needed for each process is stored; transmission and reception units 27 and 28 for performing inter-base-station communication with another base station device 1 via an X2 interface 26; and a detection unit 29 that detects, from among the MSs 2 connected to the macro BS 1a, an MS 2 located so close to another base station device 1 that it is likely to be interfered with by a downlink signal from the another base station device 1.

A plurality of methods are considered for inter-base-station communication using the X2 interface, such as a method in which base station devices are directly connected to each other via the X2 interface, and a method in which base station devices are connected to each other via a gateway.

As shown in FIG. 2, a communication line directly using the X2 interface is not provided between the femto BS 1b of the present embodiment and another base station device 1. The femto BS 1b performs inter-base-station communication with the another base station device 1 using the X2 interface, via a communication line 6 using the S1 interface that connects the femto BS 1b to the gateway 5, and the gateway 5. Hereinafter, although not specifically described, it is premised that, in the case of the femto BS 1b, the transmission and reception units 27 and 28 for inter-base-station communication perform inter-base-station communication using the X2 interface, with the another base station device 1, via the gateway 5.

The control unit 24 has a function of determining a synchronization target to be a reference for clock synchronization and timing synchronization of the macro BS 1a, and outputting a reference clock and a reference timing to the synchronization processing unit 23.

Further, the control unit 24 has a function of generating a synchronization request that requests another base station device 1 to achieve inter-base-station synchronization with the macro BS 1a being a synchronization target, and causing the transmission unit 27 to transmit the synchronization request to the another base station device 1.

When the control unit 24 has determined another base station device 1 to be a synchronization target and achieved inter-base-station synchronization with the another base station device 1, or when the control unit 24 has received a request from the another base station device 1 or a base station device 1 other than the another base station device 1, the control unit 24 causes the transmission unit 27 to transmit synchronization information relating to the synchronization state of the macro BS 1a to the another base station device 1.

The control unit 24 causes the reception unit 28 to receive, via the X2 interface 26, synchronization information relating to the synchronization state which is transmitted from another base station device 1, thereby obtaining the synchronization information.

Further, the control unit 24 has a function of performing an interference avoidance process to avoid interference with another base station device.

The control unit 24 requests another base station device 1 to provide vacant resources for avoiding interference, and allocates, in the macro BS 1a, resources corresponding to the vacant resources to an MS 2 that is likely to cause interference with the another base station device 1, thereby performing the interference avoidance process to avoid mutual interference.

In order to cause the another base station device 1 to provide a vacant resource, the control unit 24 generates a processing request that requests provision of the vacant resources, and transmits the processing request to the another base station device 1 via the transmission unit 27.

When generating the processing request, the control unit 24 determines whether the another base station device 1 is in timing synchronization with the macro BS 1a, based on the synchronization information transmitted by the another base station device 1. Based on a result of the determination, the control unit 24 determines the form of vacant resources to be requested.

More specifically, when the control unit 24 determines that the another base station device 1 is not in timing synchronization with the macro BS 1a, the control unit 24 prohibits the another base station device 1 to use resources that belong to a part of the bandwidth in the frequency direction, and determines the form of vacant resources so that the vacant resources exist continuously in the time direction.

On the other hand, when the control unit 24 determines that the another base station device 1 is in timing synchronization with the macro BS 1a, the control unit 24 prohibits the another base station device 1 from using resources that belong to a predetermined range in the time direction, and secures vacant resources in predetermined time units to determine the form of vacant resources so that the vacant resources exist intermittently in the time direction.

In this way, the control unit 24 has the function of generating, based on the obtained synchronization information, the processing request that requests execution of the interference avoidance process, and causing the transmission unit 27 to transmit the processing request to the another base station device 1.

A neighbor list 25a in which information such as cell IDs for identifying base station devices located near the macro BS 1a is registered, is stored in the memory unit 25. In the neighbor list 25a, base station devices specified as being located near the macro BS 1a may be previously inputted to be registered. Further, other base station devices 1 specified by the measurement unit 21 of the macro BS 1a, and base station devices specified by neighboring cell measurement (described later) performed by terminal devices connected to the macro BS 1a, may be registered.

The control unit 24 identifies another base station device 1 with reference to the neighbor list 25a stored in the memory unit 25, and then performs the above-described processing.

The detection unit 29 requests each MS 2 connected to the macro BS 1a to perform neighboring cell measurement (downlink signal observation). Based on a measured reception power which is a result of the measurement transmitted from each MS 2, the detection unit 29 comprehends the positional relationship between the MS 2 and another base station device 1 located near the MS 2, and detects for an MS 2 located so close to another base station device 1 that it is likely to be interfered with by a downlink signal from the another base station device 1.

In order to perform an interference avoidance process with another base station device, the macro BS 1a performs a process of comprehending and managing the synchronization state of inter-base-station synchronization in the another base station device.

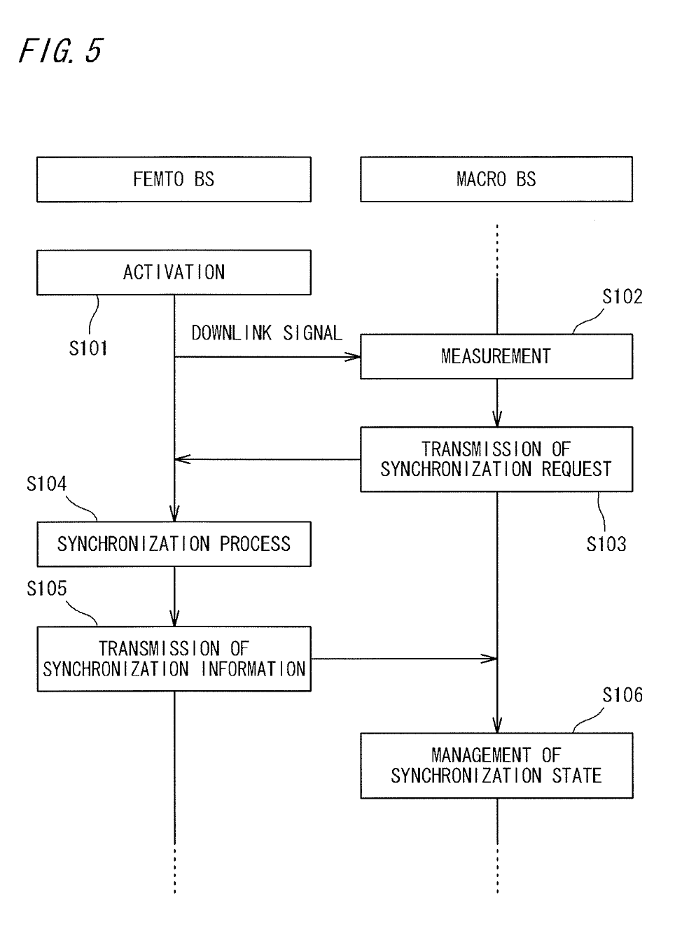

FIG. 5 is a diagram illustrating process steps relating to management of the synchronization state of inter-base-station synchronization performed between a macro base station device and a femto base station device. FIG. 5 illustrates a case where the femto BS 1b (FBS1) is installed in the macro cell MC of the macro BS 1a (MBS1) shown in FIG. 1.

First, when the femto BS 1b is installed and activated (step S101), the femto BS 1b forms a femto cell FC around itself.

Since the macro BS 1a causes the measurement unit 21 to periodically measure downlink signals of other base station devices 1, when the femto BS 1b is activated and starts to transmit a downlink signal, the macro BS 1a receives the downlink signal, and obtains the transmission power, operating frequency, and radio frame timing in the femto BS 1b, the cell ID of the femto BS 1b, and the like (step S102).

With reference to the neighbor list 25a stored in the memory unit 25, the macro BS 1a checks whether the obtained cell ID indicates a base station device located near the macro BS 1a (particularly, a femto base station device installed in the macro cell MC of the macro BS 1a).

When the femto BS 1b is registered in the neighbor list 25a of the macro BS 1a, the macro BS 1a recognizes that the femto BS 1b is a neighboring base station device.

In response to that the femto BS 1b has been detected, the macro BS 1a generates a synchronization request that requests the femto BS 1b to perform inter-base-station synchronization with the macro BS 1a being a synchronization target, and transmits the synchronization request by inter-base-station communication via the X2 interface (step S103).

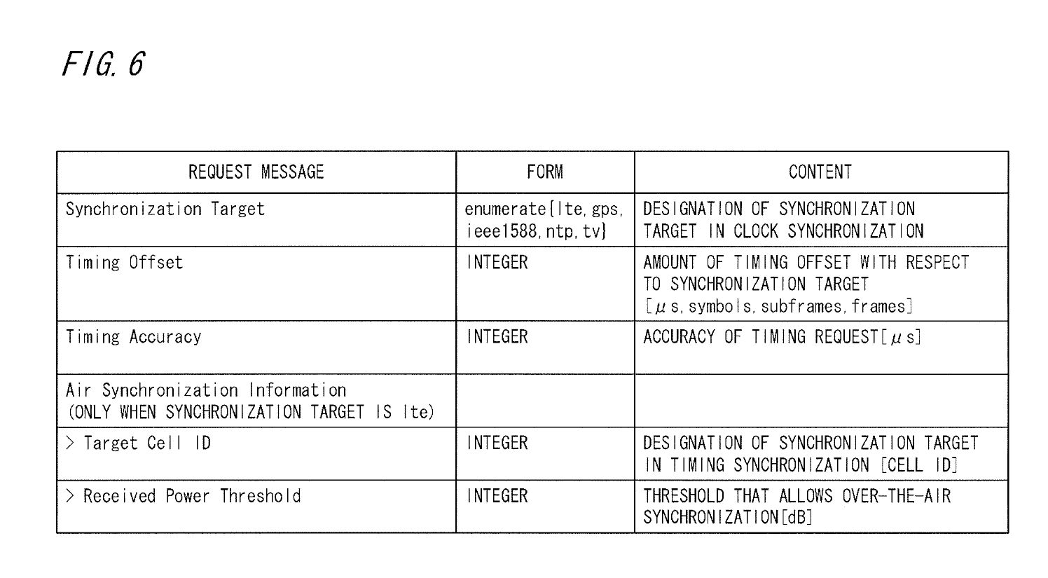

FIG. 6 is a diagram illustrating the content of request messages included in the synchronization request. The synchronization request is composed of the request messages shown in FIG. 6.

Of the request messages, “Synchronization Target” is a message that designates a synchronization target in clock synchronization. There are provided, as forms of the message, “lte” (a case where the macro BS 1a is designated as a synchronization target), “gps” (a case where a GPS is designated as a synchronization target), “ieee1588” (a case where IEEE1588 is used for synchronization), “ntp” (a case where an NTP server is designated as a synchronization target), and “tv” (a case where a television signal is designated as a synchronization target). One of them is designated.

“Timing Offset” is a message indicating an amount of offset in timing synchronization of radio frames between the macro BS 1a as a synchronization target and the femto BS 1b as another base station device. The form of this message is an integer, and its unit is any of time (μs), symbol, subframe, and radio frame.

When the femto BS 1b that has received this message determines to establish timing synchronization with the macro BS 1a, the femto BS 1b can perform a synchronization process based on the amount of offset indicated by the message.

The macro BS 1a can recognize the frame timing of the femto BS 1b from the synchronization signal included in the downlink signal of the femto BS 1b received by using the downlink signal reception unit 13, and obtain the amount of offset.

“Timing Accuracy” is a message indicating the accuracy of the request about the timing synchronization. The form of this message is an integer, and its unit is time (μs).

In a case where the femto BS 1b performs synchronization (over-the-air synchronization) by using the radio frame timing of another base station device, which is obtained from a downlink signal of the another base station device received by the downlink signal reception unit 13, “Target Cell ID” and “Received Power Threshold” which are categorized as “Air Synchronization Information” are included as request messages.

The “Target Cell ID” is a message designating a synchronization target for frame timing synchronization, and basically, it is the cell ID of the macro BS 1a. The “Received Power Threshold” is a threshold value, for the reception power from the base station device designated by the “Target Cell ID”, to determine whether over-the-air synchronization is to be performed. The reception power larger than this threshold indicates that over-the-air synchronization is allowed.

The macro BS 1a transmits the above-described synchronization request to the femto BS 1b, and thereby requests the femto BS 1b to perform inter-base-station synchronization with the synchronization target designated.

Although in FIG. 6 the synchronization target (particularly, “Target Cell ID”) is indicated by the cell ID, the manner of indicating a synchronization target is not limited to such explicit indication with a cell ID. For example, a synchronization target may be indicated by its address. Alternatively, a synchronization target may be indicated by a number, symbol or the like assigned to each of a plurality of predetermined synchronization targets.

Referring back to FIG. 5, the femto BS 1b that has received the synchronization request determines, based on the request message contained therein, whether inter-base-station synchronization is to be performed with the macro BS 1a being a synchronization target.

When the femto BS 1b determines to perform inter-base-station synchronization with the macro BS 1a being a synchronization target, and performs the synchronization process by adjusting its own frame timing with the above-described “Timing Offset” or by performing over-the-air synchronization (step S104), the femto BS 1b transmits, to the macro BS 1a, synchronization information relating to its own synchronization state (step S105).

The femto BS 1b performs, with the macro BS 1a, inter-base-station communication using the X2 interface via the gateway 5 (FIG. 2), and transmits the synchronization information.

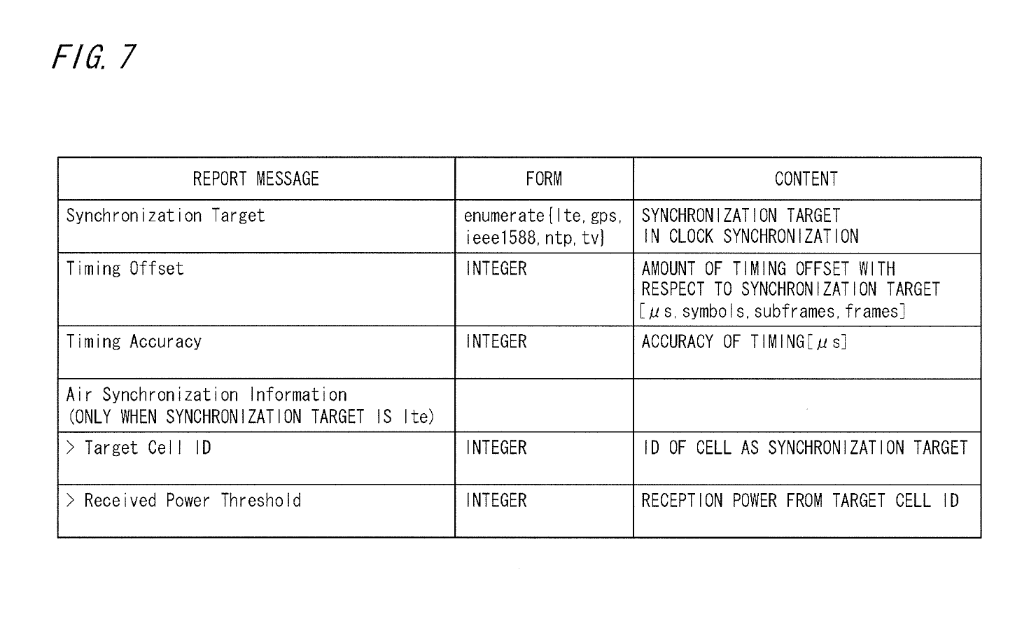

FIG. 7 is a diagram illustrating the content of report messages included in the synchronization information. The synchronization information is composed of the report messages shown in FIG. 7. Each report message and its form are similar to those of the synchronization request shown in FIG. 6. FIG. 7 shows the status after the femto BS 1b has performed the synchronization process, such as the synchronization target of the synchronization process, the current amount of timing offset, and the like.

The synchronization information transmitted from the femto BS 1b allows the macro BS 1a to comprehend the synchronization target with which the femto BS 1b has performed inter-base-station synchronization.

Also in FIG. 7, the synchronization target (particularly, “Target Cell ID”) is indicated by the cell ID. However, a synchronization target may be indicated by its address, or by a number, symbol, or the like assigned to each of a plurality of predetermined synchronization targets.

Referring back to FIG. 5, the macro BS 1a that has received the synchronization information stores, in the memory unit 25, the received synchronization information in association with the cell ID of the femto BS 1b. Thereby, the macro BS 1a can manage the synchronization state of the femto BS 1b (step S106).

Even when, in step S104, the femto BS 1b has performed inter-base-station synchronization not with the macro BS 1a but with a base station device other than the macro BS 1a, as a synchronization target, the femto BS 1b transmits the synchronization information indicating the current synchronization state to the macro BS 1a. That is, the femto BS 1b transmits the synchronization information to the base station device from which the femto BS 1b has received the synchronization request, regardless of whether the femto BS 1b has performed inter-base-station synchronization in response to the synchronization request.

As described above, the base station device 1 of the present embodiment can request another base station device like the femto BS 1b to perform inter-base-station synchronization, by transmitting the synchronization request to the another base station device. Further, based on the synchronization information transmitted from the another base station device, the base station device 1 can comprehend and manage the synchronization state of the another base station device.

The following will describe an interference avoidance process performed by the macro BS 1a that manages the synchronization state of the femto BS 1b, with the femto BS 1b.

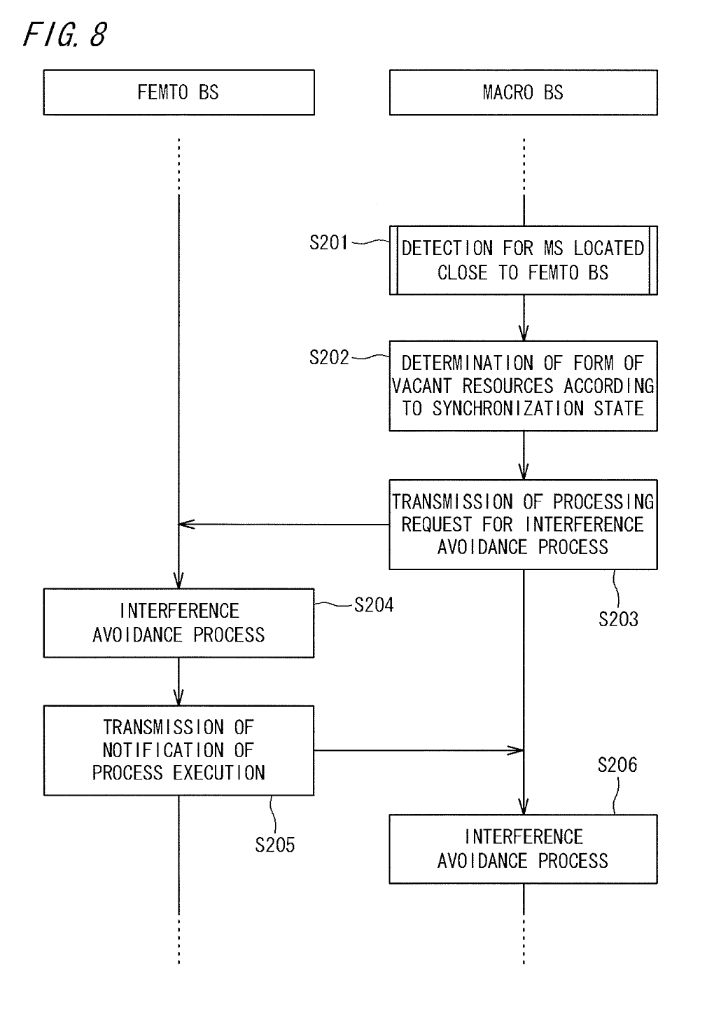

FIG. 8 is a diagram illustrating process steps relating to the interference avoidance process performed by the macro BS 1a with the femto BS 1b. Also in FIG. 8, as in FIG. 5, the interference avoidance process will be described for the case where the femto BS 1b (FBS1) is installed in the macro cell MC of the macro BS 1a (MBS1) shown in FIG. 1.

First, the macro BS 1a detects whether there is an MS 2 located close to the femto BS 1b, among the MSs 2 connected to the macro BS 1a (step S201).

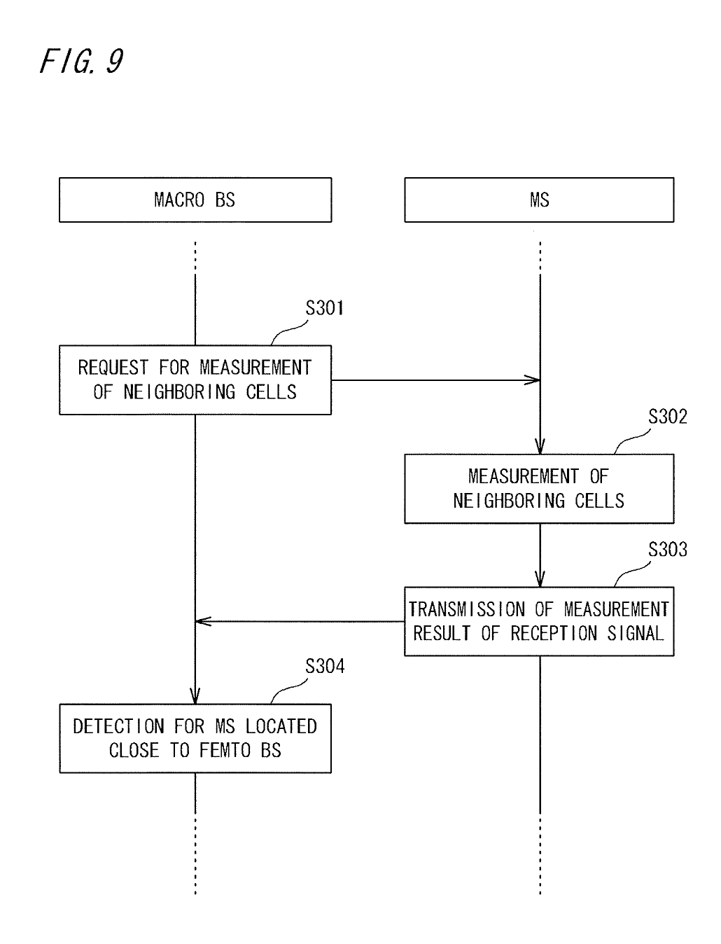

FIG. 9 is a diagram for explaining a process in which the macro BS 1a detects for an MS 2 located close to the femto BS 1b, from among the MSs 2 connected to the macro BS 1a.

First, the macro BS 1a requests each of the MSs 2 connected to the macro BS 1a to perform neighboring cell measurement (downlink signal observation) (step S301).

This request includes the above-described neighbor list 25a of the macro BS 1a. Upon receiving the request of measurement, each MS 2 attempts reception of a downlink signal from each of the base station devices listed on the neighbor list 25a, and measures a reception power of the downlink signal.

Each MS 2 transmits the measured reception power of each base station device to the macro BS 1a (step S303).

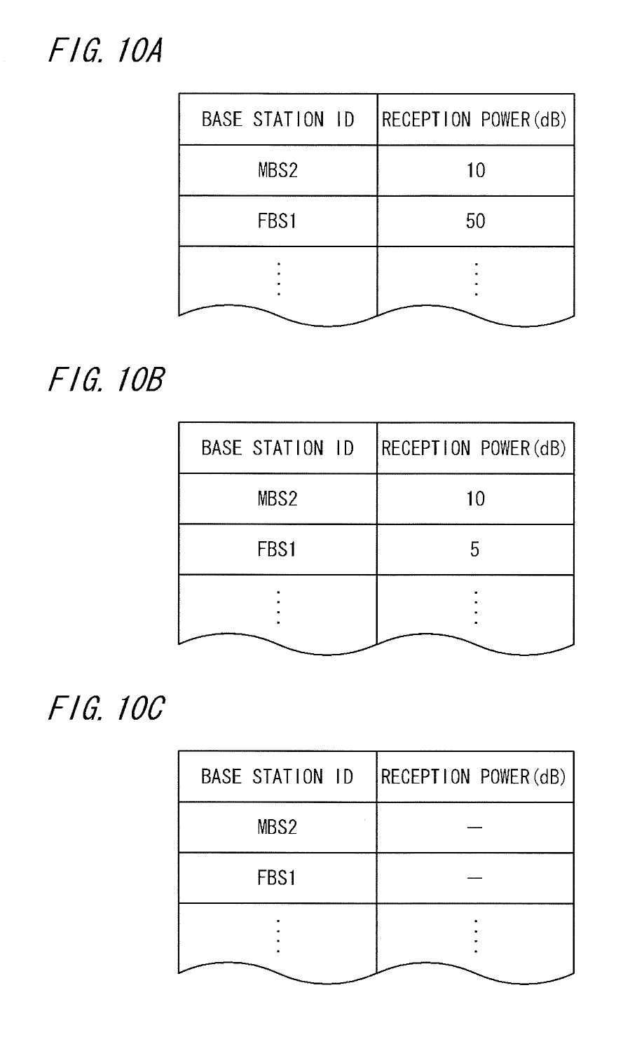

FIG. 10 is a diagram illustrating examples of the measurement results transmitted to the macro BS 1a (MBS1) in a case where, in FIG. 1, the macro BS 1a (MBS1) has made the measurement request to the MS 2a, MS 2b, and MS 2c connected to the macro BS 1a. In the measurement results, the cell IDs of the base station devices listed in the neighbor list 25a are associated with the measured reception powers.

The cell IDs of the base station devices 1 are “MBS2” and “FBS1” given to the base station devices 1 in FIG. 1. Further, in FIG. 1, the distance from the MS 2a to the macro BS 1a (MBS2) is substantially equal to the distance from the MS 2b to the macro BS 1a (MBS2), and the distance from the MS 2c to the femto BS 1b (FBS1) is longer than the distance from the MS 2b to the femto BS 1b (FBS1).

FIG. 10(a) shows an example of the measurement result of the MS 2a in FIG. 1. Since the MS 2a is located in the cell of the femto BS 1b (FBS1), the reception power of the femto BS 1b (FBS1) appears prominently. Further, since the MS 2a is close to the macro cell of the macro BS 1a (MBS2), the reception power of the macro BS 1a (MBS2) is also detected.

FIG. 10(b) shows an example of the measurement result of the MS 2b in FIG. 1. Since the MS 2b is located outside, but close to, the cell of the femto BS 1b (FBS1), the reception power of the femto BS 1b (FBS1) is detected slightly. Further, since the distance from the MS 2b to the macro BS 1a (MBS2) is substantially equal to the distance from the MS 2a to the macro BS 1a (MBS2), the reception power of the macro BS 1a (MBS2) detected by the MS2b is at the same level (10 dB) as that of the MS 2a.

FIG. 10(c) shows an example of the measurement result of the MS 2c in FIG. 1. Since the MS 2c is located distant from the cell of the femto BS 1b (FBS1) and the macro cell of the macro BS 1a (MBS2) as compared to the MS 2a and MS 2b, neither the reception power of the femto BS 1b (FBS1) nor the reception power of the macro BS 1a (MBS2) are detected by the MS 2c.

As described above, the greater the reception power of each base station device 1 which is measured by each MS 2 is, the closer the MS 2 is to the target base station device 1, although it depends on the transmission power of the base station device 1. Therefore, the reception power basically indicates the positional relationship between the MS 2 and each base station device 1.

Accordingly, by comprehending the reception power of each base station device 1 which is measured by each MS 2, the macro BS 1a can determine whether the MS 2 is likely to be interfered with by the downlink signal of the base station device 1.

Referring back to FIG. 9, when the macro BS 1a receives the measurement results of the reception powers of the respective base station devices 1 which have been transmitted from the respective MSs 2 in step S303, the macro BS 1a detects an MS 2 located close to the femto BS 1b from among the MSs 2, based on the measurement results (step S304).

For example, when the reception power of a neighboring base station device measured in an MS 2 is equal to or greater than a predetermined threshold, the macro BS 1a detects this MS 2 as one located so close to the neighboring base station device that it is likely to be interfered with by the downlink signal of the neighboring base station device. In the detection process performed in step S304, the reception powers of other macro BSs 1a are not considered because interference is less likely to occur between macro base station devices.

For example, if the predetermined threshold is 10 dB or above, the MS 2a is detected as an MS 2 located close to the femto BS 1b (FBS 1) in the measurement result shown in FIG. 10.

As described above, the macro BS 1a detects an MS 2 located so close to the femto BS 1b that it is likely to be interfered with by the femto BS 1b, from among the MSs 2 connected to the macro BS 1a.

Referring back to FIG. 8, when the MS 2a is detected in step S201 as an MS 2 located close to the femto BS 1b from among the MSs 2 connected to the macro BS 1a, the macro BS 1a refers to the memory unit 25 for the synchronization state of the femto BS 1b located close to the detected MS 2a, and determines whether the femto BS 1b is in radio-frame-timing synchronization with the macro BS 1a.

Then, in order to perform the above-described interference avoidance process, the macro BS 1a determines, based on a result of the determination, the form of vacant resources for avoiding interference, which is to be requested to the femto BS 1b (step S202).

If no MS 2 located close to the femto BS 1b is detected in step S201, the macro BS 1a does not perform the subsequent interference avoidance process but again performs detection for an MS2 located close to the femto BS 1b after a predetermined period of time.

Next, the macro BS 1a generates a processing request for realizing the form of vacant resources which has been determined based on the determination result, and transmits the processing request to the femto BS 1b (step S203).

Upon receiving the processing request, the femto BS 1b performs, based on the processing request, resource allocation to the MS 2d connected to the femto BS 1b, within a range of resources other than the range that the femto BS 1b is prohibited to use (vacant resources). Thereby, the interference avoidance process on the femto BS 1b side is performed (step S204).

Upon completing the above-described processing by performing the resource allocation, the femto BS 1b notifies the macro BS 1a that the processing has been executed (step S205).

Upon receiving the notification from the femto BS 1b, the macro BS 1a allocates the resources in the range that the femto BS 1b is prohibited to use (vacant resources), to the MS 2a detected as an MS 2 located close to the femto BS 1b. Thereby, the interference avoidance process on the macro BS 1a side is performed (step S206).

As a result, the resources allocated to the MS 2a which is likely to cause interference with the femto BS 1b are not used by the femto BS 1b, and therefore, it is possible to avoid interference between the MS 2a and the femto BS 1b.

Since the MS 2b and the MS 2c are less likely to cause interference with the femto BS 1b, other resources can be allocated to these MSs.

When it is determined in step S202 that the femto BS 1b is not in radio-frame-timing synchronization with the macro BS 1a, the macro BS 1a prohibits the femto BS 1b from using the resources that belong to a part of the bandwidth in the frequency direction, and determines the form of vacant resources so that the vacant resources exist continuously in the time direction. The macro BS 1a transmits a processing request according to the form of the vacant resources to the femto BS 1b.

In this case, the resource allocations performed by the both base station devices are as follows.

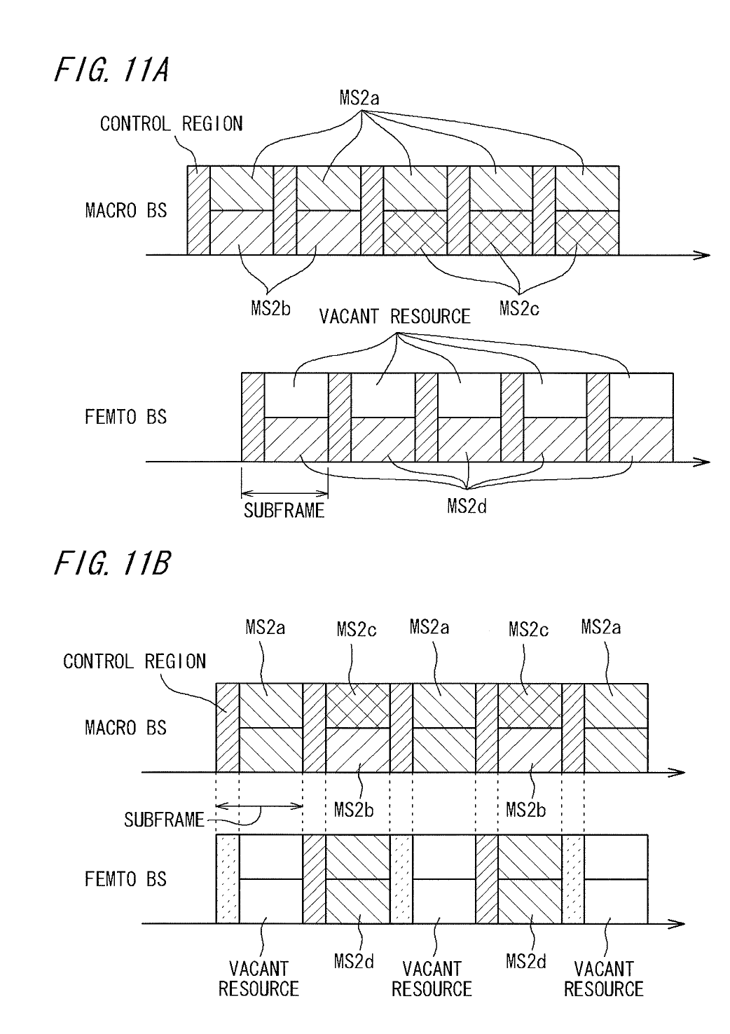

FIG. 11(a) is a diagram illustrating examples of resource allocations performed by the macro BS 1a (MBS1) and the femto BS 1b (FBS1) shown in FIG. 1 when radio-frame-timing synchronization is not achieved between these base stations.

With reference to FIG. 11(a), the femto BS 1b allocates resources other than a part of the bandwidth that the femto BS 1b is prohibited to use, to the MS 2d connected to the femto BS 1b. Thereby, vacant resources continuously exist in the time direction.

The macro BS 1a allocates the resources corresponding to the vacant resources to the MS 2a that is likely to be interfered with by the femto BS 1b, and allocates other resources to the MS 2b and the MS 2c that are less likely to be interfered with by the femto BS 1b.

In this case, since the vacant resources exist continuously in the time direction, even if radio-frame-timing synchronization is not achieved between the macro BS 1a and the femto BS 1b, it is possible to prohibit the femto BS 1b from using resources in a predetermined bandwidth, and cause the femto BS 1b to provide vacant resources, and thus interference between the macro BS 1a and the femto BS 1b can be avoided.

On the other hand, when it is determined in step S202 that the femto BS 1b is in radio-frame-timing synchronization with the macro BS 1a, the macro BS 1a prohibits the femto BS 1b from using resources that belong to a predetermined range in the time direction, and secures vacant resources in predetermined time units to determine the form of the vacant resources so that the vacant resources exist intermittently in the time direction. The macro BS 1a transmits, to the femto BS 1b, a processing request corresponding to the determined form of the vacant resources.

In this processing request, if securing of the vacant resources is performed in subframe units, the vacant resources can be designated by a parameter that can specify sections in the time direction, such as the subframe numbers in the downlink signal of the macro BS 1a, or by a parameter that can specify sections in the time direction, such as the subframe numbers in the downlink signal of the femto BS 1b. Since the macro BS 1a and the femto BS 1b recognize the amount of offset between the radio frames thereof, the reference of the parameter of the processing request may be previously determined and set in either the macro BS 1a or the femto BS 1b.

In this case, the resource allocations performed by the both base station devices are as follows.

FIG. 11(b) is a diagram illustrating examples of resource allocations performed by the macro BS 1a (MBS1) and the femto BS 1b (FBS1) shown in FIG. 1 when radio-frame-timing synchronization is achieved between these base stations.

With reference to FIG. 11(b), the femto BS 1b is prohibited to use every other subframes, and performs resource allocation to the MS 2d connected to the femto BS 1b, by using subframes other than the prohibited subframes. Thereby, vacant resources intermittently exist in subframe units in the time direction.

The macro BS 1a allocates the resources corresponding to the vacant resources, to the MS 2a which is likely to be interfered with by the femto BS 1b, and allocates other resources to the MS 2b and the MS 2c which are less likely to be interfered with by the femto BS 1b.

In this case, since radio-frame-timing synchronization is achieved between the macro BS 1a and the femto BS 1b, the macro BS 1a can request the femto BS 1b to secure vacant resources in predetermined time units and provide the vacant resources intermittently in the time direction, and can specify the range of the vacant resources intermittently existing in the time direction. Therefore, the macro BS 1a can allocate the resources corresponding to the vacant resources to the MS 2a which is likely to be interfered with by the femto BS 1b, thereby avoiding mutual interference.

Further, as shown in FIG. 11(b), in the case where the resources to be used by the macro BS 1a and the femto BS 1b are prevented from overlapping in the time direction by securing the vacant resources in predetermined time units, the data signals of the BSs never overlap each other in the time domain. Further, regarding the control signal, since no substantial control signal is allocated to a control region of a subframe in a time to which no resource is allocated, it is possible to prevent the control signal from interfering with the other control signal.

As described above, in the present embodiment, it is possible to execute an appropriate interference avoidance process in accordance with the synchronization state of the femto BS 1b as another base station device, by transmitting the processing request according to the determination, based on the synchronization information, as to whether synchronization is achieved.

The present invention is not limited to the above-described embodiment. In the above-described embodiment, the macro BS 1a recognizes the presence of the femto BS 1b by the measurement in step S102, in the process shown in FIG. 5 relating to management of the synchronization state of inter-base-station synchronization. However, for example, the macro BS 1a may periodically transmit the synchronization request via the X2 interface to all the femto base station devices registered in the neighbor list 25a. In this case, the macro BS 1a may manage the synchronization information for only femto base station device(s) that has transmitted the synchronization information in response to the synchronization request.

Further, in the above-described embodiment, after the femto BS 1b is activated in step S101 in FIG. 5, the femto BS 1b may autonomously perform the synchronization process by over-the-air synchronization with the macro BS 1a, and may transmit the synchronization information. That is, the macro BS 1a can manage the synchronization state of the femto BS 1b with steps S102 and S103 in FIG. 5 being omitted.

Further, although FIG. 11(b) shows the case where the femto BS 1b provides the vacant resources in units of subframes, the femto BS 1b may provide the vacant resources in units of radio frames, units of slots constituting a subframe, or units of resource blocks.

Note that the embodiment disclosed in the present invention is to be considered in all respects as illustrative and not restrictive.

Although in the above-described embodiment the present invention is applied to a system for mobile phones to which LTE is applied, the communication scheme is not limited to the LTE.

The scope of the invention is not limited to the foregoing meaning, and all changes which come within the meaning and range of equivalency of the claims are therefore intended to be embraced therein.

### DESCRIPTION OF THE REFERENCE CHARACTERS

1 base station device

2 terminal device

24 control unit

26 X2 interface

27 transmission unit

28 reception unit

29 detection unit

1. A base station device, including:
a reception unit which receives, via an inter-base-station communication interface that enables inter-base-station communication, synchronization information relating to a synchronization state of inter-base-station synchronization, the synchronization information being transmitted from another base station device.

2. The base station device according to claim 1, further including:
a transmission unit which transmits, via the inter-base-station communication interface, a synchronization request that requests the another base station device to achieve inter-base-station synchronization with the base station device.

3. The base station device according to claim 2, wherein the synchronization request includes an amount of timing offset of a communication timing to be adjusted by the another base station device.

4. The base station device according to claim 1, wherein the synchronization information includes a clock synchronization target with which the another base station device synchronizes its own internal clock.

5. The base station device according to claim 1, wherein the synchronization information includes an amount of timing offset between a communication timing of the base station device and a communication timing of the another base station device.

6. The base station device according to claim 2, further including:
a detection unit which detects for, among terminal devices connected to the base station device, a terminal device that is located so close to the another base station device that it is likely to be interfered with by a downlink signal from the another base station device; and
a control unit which, when the detection unit detects such a terminal device located close to the another base station device, generates, based on the synchronization information, a processing request for requesting the another base station device to execute an interference avoidance process for avoiding interference between the terminal device and the another base station device, and then causing the transmission unit to transmit the processing request to the another base station device.

7. The base station device according to claim 6, wherein the processing request requests the another base station device to provide vacant resources for avoiding interference between the another base station device and the terminal device located close to the another base station device.

8. The base station device according to claim 7, wherein
the control unit determines, based on the synchronization information, whether the communication timing of the another base station device is synchronized with that of the base station device, and upon determining that the communication timings are synchronized with each other, the control unit generates a processing request that requests the another base station device to secure the vacant resources in predetermined time units.

9. A base station device, including:
a transmission unit which transmits synchronization information relating to a synchronization state of inter-base-station synchronization, to another base station device via an inter-base-station communication interface that enables inter-base-station communication.

10. An inter-base-station synchronization method for achieving synchronization between base station devices, comprising the steps of:
transmitting, from one of the base station devices to the other base station device, an synchronization request that requests the other base station device to achieve inter-base-station synchronization with the one base station device, via an inter-base-station communication interface that allows inter-base-station communication; and
transmitting, from the other base station device to the one base station device, synchronization information relating to a synchronization state of inter-base-station synchronization via the inter-base-station communication interface.

11. A base station device which transmits synchronization information, wherein
the synchronization information indicates information relating to a synchronization state of inter-base-station synchronization in the base station device, and includes synchronization target information indicating a synchronization target in the inter-base-station synchronization.

12. A base station device which transmits synchronization information, wherein
the synchronization request indicates that the base station device requests another base station device to perform inter-base-station synchronization, and includes synchronization target information indicating a synchronization target in the inter-base-station synchronization.
